(19) United States
(12) Patent Application Publication
(10) Pub. No.: US 2024/0289196 A1
(43) Pub. Date: Aug. 29, 2024

(54) ANOMALY DETECTION DEVICE, PROCESSING DEVICE, ANOMALY DETECTION METHOD, AND COMPUTER PROGRAM PRODUCT

(71) Applicant: KABUSHIKI KAISHA TOSHIBA, Tokyo (JP)

(72) Inventors: Yuki ISODA, Kawasaki (JP); Daisuke KOBAYASHI, Tachikawa (JP); Tomoyuki SHIBATA, Kawasaki (JP)

(73) Assignee: KABUSHIKI KAISHA TOSHIBA, Tokyo (JP)

(21) Appl. No.: 18/517,036

(22) Filed: Nov. 22, 2023

(30) Foreign Application Priority Data
Feb. 28, 2023 (JP) 2023-029811

(51) Int. Cl. G06F 11/07

(52) U.S. Cl. CPC G06F 11/0751

(57) ABSTRACT

An anomaly detection device according to an embodiment includes a parameter set storage unit, a detection unit, an information input unit, and a processing unit. The parameter set storage unit stores a plurality of parameter sets used for detecting an anomaly in at least one piece of target data. The detection unit detects an anomaly in the at least one piece of target data using at least one parameter set selected from the parameter sets, and acquires at least one detection result. The information input unit receives an input of teaching information corresponding to the at least one detection result. The processing unit performs at least one of update, addition, and deletion of the parameter set based on the teaching information.

### CROSS-REFERENCE TO RELATED APPLICATIONS

This application is based upon and claims the benefit of priority from Japanese Patent Application No. 2023-029811, filed on Feb. 28, 2023; the entire contents of which are incorporated herein by reference.

### FIELD

Embodiments described herein relate generally to an anomaly detection device, a processing device, an anomaly detection method, and a computer program product.

### BACKGROUND

In the related art, there is known an anomaly determination device that monitors a status of an operation and determines an anomaly. For example, in the related art, there is known a technique of updating an anomaly determination algorithm when a user teaches whether a determination result obtained by the anomaly determination device is correct.

However, in the related art, it has been difficult to detect a larger number of anomalies with higher accuracy.

### BRIEF DESCRIPTION OF THE DRAWINGS

FIG. 1 is a block diagram illustrating an example of a schematic configuration of an anomaly detection device;

FIG. 2 is a block diagram illustrating an example of a configuration of an anomaly detection device according to a first embodiment;

FIG. 3 is a diagram illustrating an example of a plurality of parameter sets stored in a parameter set storage unit according to the first embodiment;

FIG. 4 is a diagram illustrating an example of a final detection result obtained by a detection unit according to the first embodiment;

FIG. 5 is a flowchart illustrating an example of a main procedure of an anomaly detection method according to the first embodiment;

FIG. 6 is a flowchart illustrating an operation example of a processing unit according to the first embodiment;

FIG. 7 is a flowchart illustrating an operation example of an information input unit according to the first embodiment;

FIG. 8 is a block diagram illustrating an example of a configuration of an anomaly detection device according to a second embodiment;

FIG. 9 is a diagram illustrating an example of a plurality of parameter sets stored in a parameter set storage unit according to the second embodiment;

FIG. 10 is an example of a detection result of a tree structure model according to the second embodiment;

FIG. 11 is a flowchart illustrating an operation example of a processing unit according to the second embodiment;

FIG. 12 is a block diagram illustrating an example of a configuration of an anomaly detection device according to a third embodiment;

FIG. 13 is a diagram illustrating an example of display information according to the third embodiment (in a case of update check);

FIG. 14 is a diagram illustrating an example of display information according to the third embodiment (in a case of deletion check); and

FIG. 15 is a diagram illustrating an example of a hardware configuration of the anomaly detection device according to the first to the third embodiments.

### DETAILED DESCRIPTION

According to an embodiment, an anomaly detection device includes a parameter set storage device configured to store therein a plurality of parameter sets used for detecting an anomaly in at least one piece of target data; and one or more hardware processors communicably coupled to the parameter set storage unit and configured to function as a detection unit, an information input unit, and a processing unit. The detection unit is configured to detect an anomaly in the at least one piece of target data using at least one parameter set selected from the parameter sets, and acquire at least one detection result. The information input unit is configured to receive an input of teaching information corresponding to the at least one detection result. The processing unit is configured to perform at least one of update, addition, and deletion of the parameter set based on the teaching information. The following describes embodiments of an anomaly detection device, a processing device, an anomaly detection method, and a computer program product in detail with reference to the attached drawings.

The number of determination algorithms (for example, data in which various functions and various parameters are compiled) is limited, so that there is the problem that all anomalies cannot be necessarily detected with high accuracy. Additionally, regarding teaching by a user, there is also the problem that cost for teaching whether all anomaly determination results are correct is high. In a case of teaching only a result determined to be abnormal (determined as an anomaly), there is the problem that anomaly data determined to be normal cannot be collected and undetection cannot be suppressed.

First, the following describes a schematic configuration of the anomaly detection device that solves such problems.

### Example of Schematic Configuration

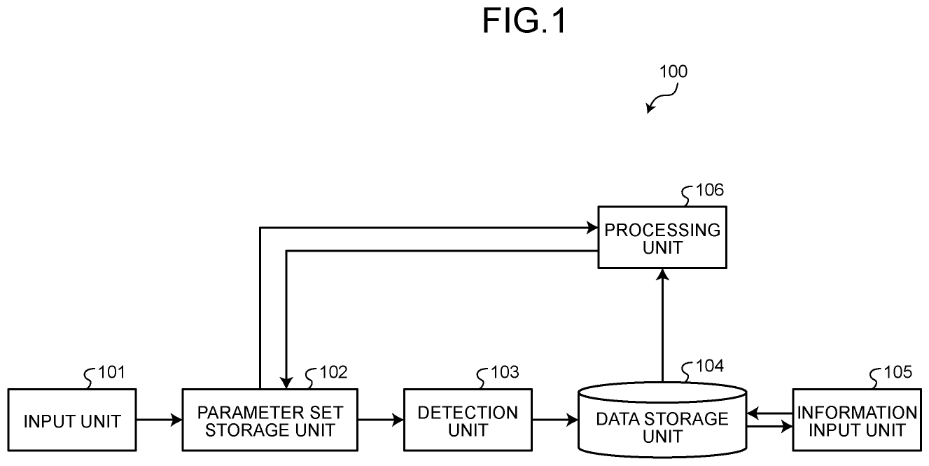

FIG. 1 is a block diagram illustrating an example of a schematic configuration of an anomaly detection device 100. The anomaly detection device 100 receives an input of a signal indicating target data, and detects presence/absence of an anomaly in the target data. The anomaly detection device 100 may be disposed in a device that outputs the signal, or disposed outside the device that outputs the signal. As illustrated in FIG. 1, the anomaly detection device 100 includes an input unit 101, a parameter set storage unit 102, a detection unit 103, a data storage unit 104, an information input unit 105, and a processing unit 106.

The input unit 101 receives an input of a signal output from a sensor, for example. The input unit 101 may be a device itself such as a sensor that outputs a signal indicating measured information.

The parameter set storage unit 102 stores a plurality of parameter sets used for detecting an anomaly in the target data. The parameter set is data in which parameters that can be set for anomaly detection are compiled. Parameters included in the parameter set are, for example, adjustable parameters that affect anomaly detection such as a parameter for preprocessing input data and a parameter for calculating an anomaly degree indicating a degree of an anomaly.

The adjustable parameter may be a parameter for changing a threshold, for example. For example, the adjustable parameter may be a parameter obtained by compiling weights to be calculated such as a neural network (NN). For example, the adjustable parameter may be a parameter for selecting an algorithm and the like used for calculation that affect presence/absence of anomaly detection.

The parameter set storage unit 102 may further store a relation among the parameter sets for constructing a tree structure model. For example, the parameter set storage unit 102 may further store a relation such that a parameter set A is a root node, and a parameter set B is present on a left side thereof as a child node.

The detection unit 103 detects presence/absence of an anomaly based on a signal input to the input unit 101 and the parameter sets stored in the parameter set storage unit 102. The detection unit 103 outputs a plurality of detection results using the respective parameter sets. The detection unit 103 may output not only individual detection results obtained with the respective parameter sets but also a detection result obtained by compiling detection results of the parameter sets, or a detection result obtained by compiling detection results of a plurality of the tree structure models. As a method of compiling the detection results, for example, adopting a majority determination for the detection results indicating an anomaly or normality is thinkable.

The data storage unit 104 stores a detection result output from the detection unit 103. The data storage unit 104 also receives teaching information input from the information input unit 105 (described later), and stores it together with the detection result output from the detection unit 103. The detection result may be directly output to the information input unit 105 (described later). The detection result may be output to the information input unit 105 in a case of receiving an instruction from the information input unit 105.

The information input unit 105 receives the teaching information as a result of determining whether the detection result is correct by the user. The information input unit 105 stores the teaching information in the data storage unit 104. The information input unit 105 receives the teaching information input via an external terminal including a display device, an input device, and the like, for example. The information input unit 105 may have both functions of the display device and the input device. The information input unit 105 may directly receive the input detection result from the detection unit 103. The information input unit 105 may receive a detection result having a higher teaching priority from the data storage unit 104 with priority. Furthermore, the information input unit 105 may transmit an instruction to the data storage unit 104, and may receive a detection result from the data storage unit 104 in accordance with the instruction.

The processing unit 106 performs at least one of update processing, addition processing, and deletion processing for each of the parameter sets stored in the parameter set storage unit 102 based on the detection result and the teaching information stored in the data storage unit 104. The update processing is performed for the purpose of improving detection accuracy of the parameter set. The addition processing is performed for the purpose of correctly detecting data that is difficult to be correctly detected only with existing parameter sets. The deletion processing is performed for the purpose of not using memory capacity for unnecessary parameter sets.

The parameter set storage unit 102 and the data storage unit 104 may be implemented by one storage unit.

### First Embodiment

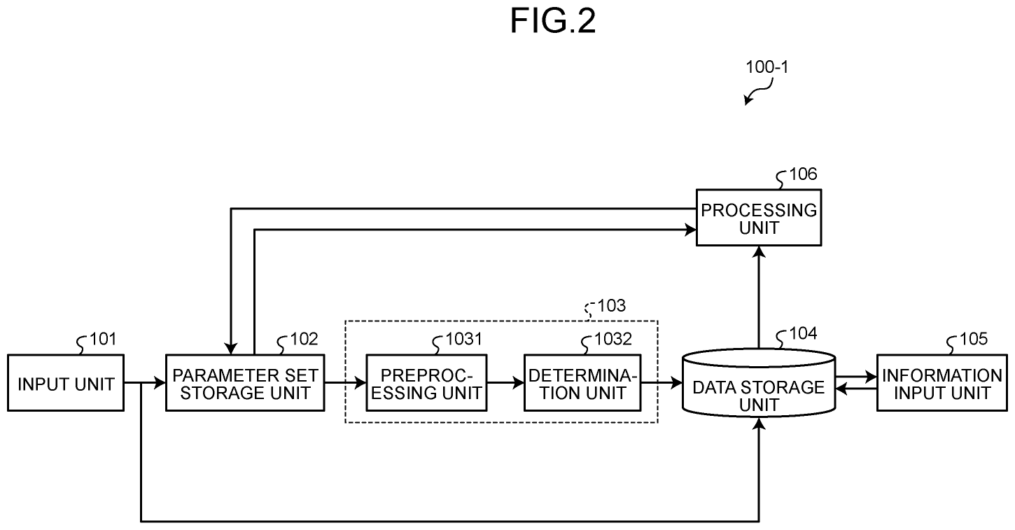

FIG. 2 is a block diagram illustrating an example of a configuration of an anomaly detection device 100-1 according to a first embodiment. The anomaly detection device 100-1 according to the first embodiment includes the input unit 101, the parameter set storage unit 102, the detection unit 103, the data storage unit 104, the information input unit 105, and the processing unit 106.

The input unit 101 receives an input of a signal. For example, a signal indicating an image is input to the input unit 101 once per second from one imaging device. The signal input to the input unit 101 is firstly stored in the data storage unit 104 as raw data.

As illustrated in FIG. 2, the detection unit 103 according to the first embodiment includes a preprocessing unit 1031 and a determination unit 1032. Each of the preprocessing unit 1031 and the determination unit 1032 performs processing based on each of the parameter sets stored in the parameter set storage unit 102 and a detection algorithm for performing detection using each of the parameter sets.

The preprocessing unit 1031 calculates a characteristic amount from an image based on each of the parameter sets in the parameter set storage unit 102. The preprocessing unit 1031 calculates the characteristic amount based on a weight parameter learned by using deep learning, for example.

The determination unit 1032 determines whether an anomaly has occurred from the characteristic amount calculated by the preprocessing unit 1031 based on each of the parameter sets in the parameter set storage unit 102. The determination unit 1032 determines, for example, an outlier from distribution of normal data as an anomaly. Details of an anomaly detection method using the parameter sets will be described later.

Detection results based on the respective parameter sets are stored in the data storage unit 104.

The information input unit 105 receives, from the user, an instruction to output the detection result stored in the data storage unit 104. For example, in a case of desiring to teach teaching information related to whether the detection result is correct, the user inputs, to the information input unit 105, an instruction to output the detection result. The information input unit 105 has a function of receiving the detection result from the data storage unit 104 and displaying the detection result to the user, and receives the teaching information corresponding to the detection result from the user. The information input unit 105 transmits the teaching information to the data storage unit 104 to be stored therein together with the detection result.

The data storage unit 104 has a function of storing teaching priority for teaching the detection result, and transmits the detection result to the information input unit 105 in accordance with the teaching priority. That is, the information input unit 105 displays the detection result of the target data in accordance with the teaching priority, and receives an input of the teaching information corresponding to the displayed detection result of the target data. A method for determining the teaching priority will be described later.

First, the processing unit 106 performs the following update processing for all of the parameter sets, and determines whether to update the parameter sets. For example, the processing unit 106 updates the parameter set in a case in which a predetermined condition is satisfied. An update condition is, for example, whether the number of pieces of the teaching information stored in the data storage unit 104 is increased by the certain number or more from previous update.

The processing unit 106 calculates scores of the parameter sets based on a predetermined score function in a case in which the update condition is satisfied, and updates the parameter set in the parameter set storage unit 102 by the parameter set the score of which is higher. The predetermined score function is, for example, detection accuracy. Furthermore, the processing unit 106 also stores the detection accuracy of the updated parameter set in the parameter set storage unit 102 together with the updated parameter set.

For example, the processing unit 106 searches the parameter sets in the vicinity of a current parameter set (parameter sets close to a value of the current parameter set) for the parameter set. The processing unit 106 detects an anomaly in the raw data in the data storage unit 104 using the searched parameter set, and calculates the score of the parameter set based on the teaching information. The processing unit 106 updates the current parameter set with the parameter set the score of which is the highest.

Next, after performing the update processing for the parameter set, the processing unit 106 deletes the parameter set or adds a new parameter based on whether a change of the score between before the update and after the update is smaller than a certain value. The parameter set is deleted in a case in which the change of the score is small, and the score cannot be improved even if the parameter set is updated.

### Deletion of Parameter Set

For example, in a case in which the change of the score is smaller than a first threshold between before the update of the parameter set and after the update of the parameter set and the score after updating the parameter set is smaller than a second threshold, the processing unit 106 deletes the parameter set from the parameter set storage unit 102. This processing is performed to reduce memory capacity by deleting the parameter set the score of which is low and incapable of being improved by update.

Additionally, for example, in a case in which changes of the scores of the parameter sets after the update are smaller than a certain value and a ratio at which detection results of the parameter sets agree with each other is equal to or larger than a certain ratio, the processing unit 106 deletes one of the parameter sets. This is because it is not necessary to provide a plurality of the parameter sets the score of which cannot be improved by update that return the same detection result.

### Addition of New Parameter Set

Next, in a case in which the parameter set is not deleted, the processing unit 106 determines whether to add a new parameter set. In a case in which the score of the parameter set after the update is equal to or larger than the certain value, the processing unit 106 adds a new parameter set to the parameter set storage unit 102. In addition of the parameter set, the parameter set different from the existing parameter sets is searched for, and the parameter set the score of which is equal to or larger than the certain value is added.

For example, in a case in which an addition condition is satisfied, the processing unit 106 adds a new parameter set for re-detecting the target data detected to be normal to suppress undetection of an anomaly. For example, in a case in which the addition condition is satisfied, the processing unit 106 adds a new parameter set for re-detecting the target data detected to be abnormal to suppress excessive detection of an anomaly. The addition condition is, for example, a case in which the change of the score is smaller than the first threshold between before the update of the parameter set and after the update of the parameter set and the score after updating the parameter set is equal to or larger than the second threshold.

Anomaly Detection with Plurality of Parameter Sets

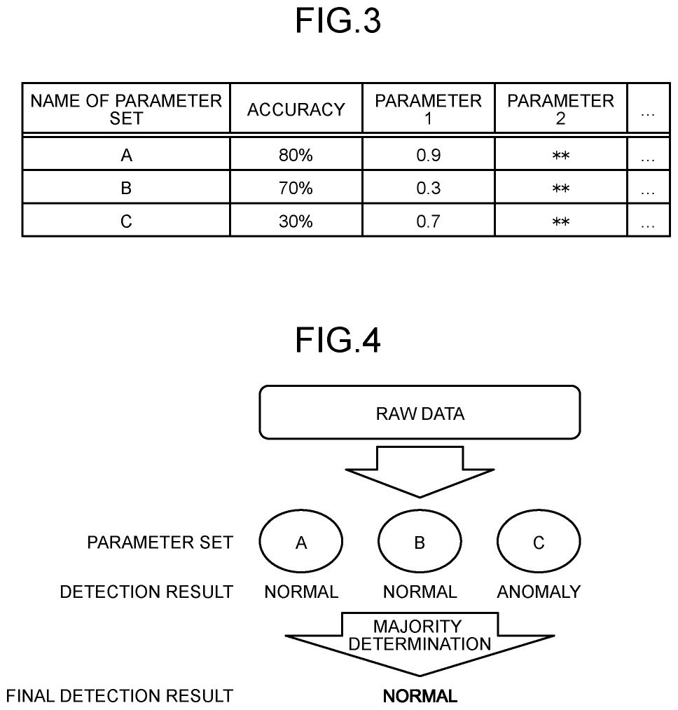

FIG. 3 is a diagram illustrating an example of the parameter sets stored in the parameter set storage unit according to the first embodiment. FIG. 4 is a diagram illustrating an example of a final detection result obtained by the detection unit according to the first embodiment.

By using examples in FIG. 3 and FIG. 4, the following describes an example of the anomaly detection method with the parameter sets performed by the detection unit 103 (the preprocessing unit 1031 and the determination unit 1032). FIG. 3 illustrates an example of each of the parameter sets stored in the parameter set storage unit 102. In the example of FIG. 3, the detection accuracy of the parameter set is stored together with each of the parameter sets. Herein, description will be made by using the detection accuracy as an example of the score calculated from the predetermined score function.

FIG. 4 represents a data flow at the time of performing anomaly detection with the parameter sets in FIG. 3. In the example of FIG. 4, the determination unit 1032 performs anomaly detection using the parameter sets, and adopts a majority determination to determine a final detection result. As another method for determining the final detection result, for example, exemplified is a weighted majority determination and the like using accuracy of each parameter set.

### Teaching Priority of Data

Similarly, the following describes an example of a method for determining teaching priority of a detection result as a teaching target using the example of FIG. 3. The determination unit 1032 determines the score of the corresponding parameter set based on the detection result of each of the parameter sets, and determines the teaching priority to be higher as the score is lower. Herein, description will be made by using the detection accuracy as an example of the score calculated by the predetermined score function.

Specifically, first, in a case in which an anomaly is determined with the parameter set A the detection accuracy of which is the highest, the determination unit 1032 determines the teaching priority using the detection accuracy of the parameter set A. Next, in a case in which normality is determined with the parameter set A and an anomaly is determined with the parameter set B, the determination unit 1032 determines the teaching priority using the detection accuracy of the parameter set B. Finally, in a case in which normality is determined with the parameter sets A and B and an anomaly is determined with a parameter set C, the determination unit 1032 determines the teaching priority using the detection accuracy of C. Reliability of the target data is low in a case in which an anomaly is detected only with the parameter set the detection accuracy of which is low, and when the user teaches the target data with priority, the parameter set the detection accuracy is low can be efficiently updated. In a case in which normality is determined with A, B, and C, the determination unit 1032 determines the teaching priority to be 0.

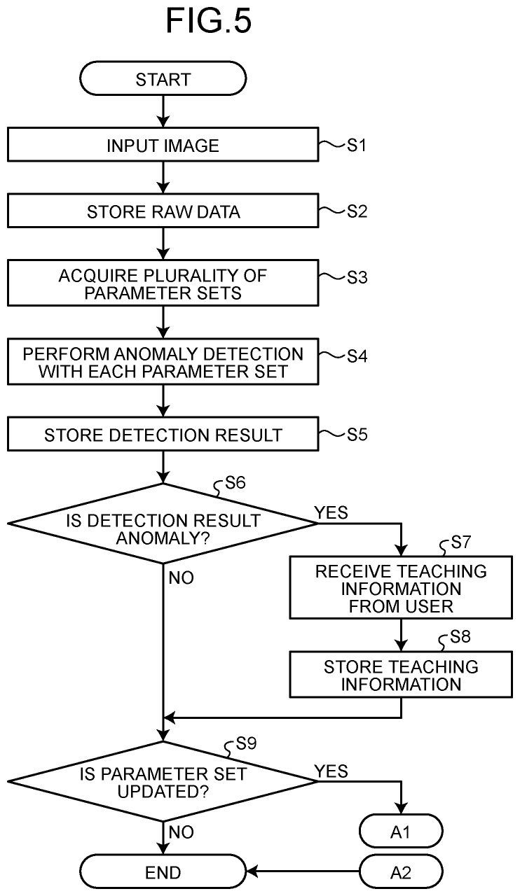

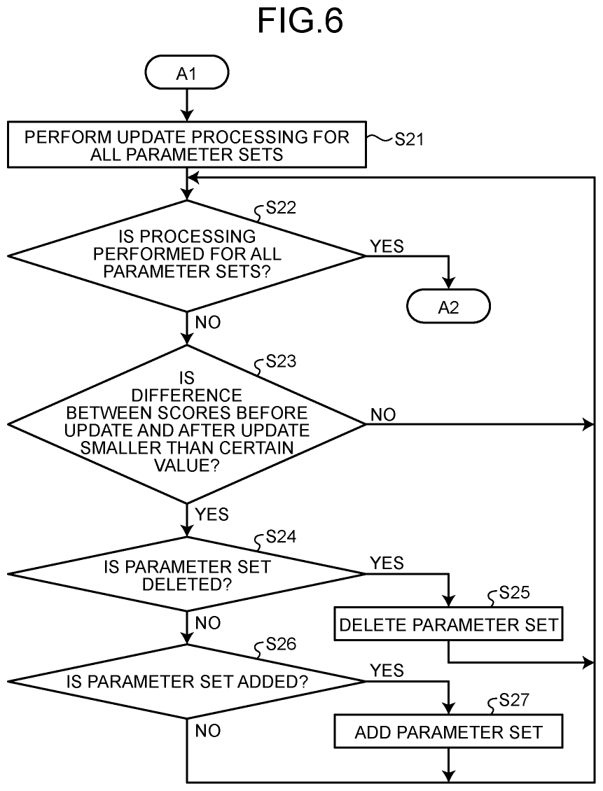

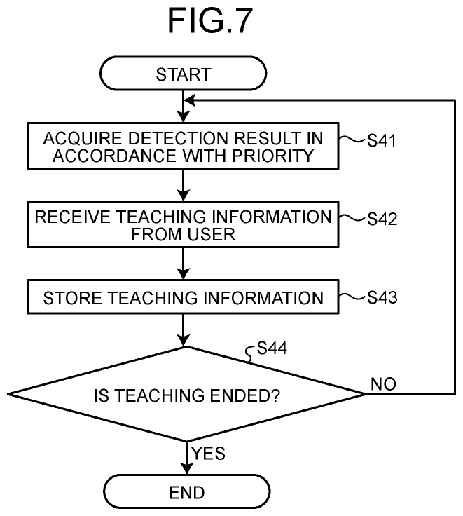

With reference to FIG. 5, FIG. 6, and FIG. 7, the following describes an example of the anomaly detection method performed by the anomaly detection device 100-1 in FIG. 2.

### Example of Main Procedure of Anomaly Detection

FIG. 5 is a flowchart illustrating a main procedure of the anomaly detection method according to the first embodiment. First, the input unit 101 receives an input of a signal indicating an image (Step S1), and the data storage unit 104 stores the image as raw data (Step S2). Next, the detection unit 103 (the preprocessing unit 1031 and the determination unit 1032) acquires the parameter sets from the parameter set storage unit 102 (Step S3), and performs anomaly detection based on each of the parameter sets (Step S4). The detection unit 103 stores the detection result based on each of the parameter sets in the data storage unit 104 (Step S5).

If the detection result is an anomaly (Yes at Step S6), the information input unit 105 receives an input of teaching information from the user (Step S7), the data storage unit 104 stores the teaching information (Step S8), and the process proceeds to Step S9. If the detection result is not an anomaly (No at Step S6), that is, if the detection result is normal, the process proceeds to Step S9.

Processes at Step S6 to S8 are not essential, and the process may proceed to Step S9 from Step S5.

Next, the processing unit 106 determines whether to update the parameter set (Step S9). In a case of not updating the parameter set (No at Step S9), the processing ends. In a case of updating the parameter set (Yes at Step S9), the process proceeds to A1 in FIG. 6.

### Operation Example of Processing Unit 106

FIG. 6 is a flowchart illustrating an operation example of the processing unit 106 according to the first embodiment. The following describes a processing procedure performed by the processing unit 106 from A1 in FIG. 6. First, the processing unit 106 performs the update processing described above for all of the parameter sets (Step S21). Next, the processing unit 106 repeatedly performs Step S23 and the following processing for each of the parameter sets.

If Step S23 and the following processing are not performed for all of the parameter sets (No at Step S22), the processing unit 106 determines, for an unprocessed parameter set, whether a difference between scores before the update and after the update of the parameter set is smaller than the certain value (first threshold) (Step S23).

If the difference between the scores before the update and after the update of the parameter set is not smaller than the certain value (No at Step S23), the process returns to Step S22.

If the difference between the scores is smaller than the certain value (Yes at Step S23), the processing unit 106 determines whether to delete the parameter set (Step S24). In a case of deleting the parameter set (Yes at Step S24), the processing unit 106 deletes the parameter set (Step S25), and the process returns to Step S22.

In a case of not deleting the parameter set (No at Step S24), the processing unit 106 determines whether to add a new parameter set (Step S26). In a case of adding a new parameter set (Yes at Step S26), the processing unit 106 adds a new parameter set (Step S27), and the process returns to Step S22. In a case of not adding a new parameter set (No at Step S26), the process returns to Step S22.

If Step S23 and the following processing are performed for all of the parameter sets (Yes at Step S22), the process proceeds to A2 in FIG. 5 described above, and the processing ends.

### Operation Example of Information Input Unit 105

FIG. 7 is a flowchart illustrating an operation example in a case in which the information input unit 105 according to the first embodiment receives an instruction to display the detection result from the user. First, the information input unit 105 acquires the detection result from the data storage unit 104 in accordance with the teaching priority of the detection result as a teaching target (Step S41). Next, the information input unit 105 receives the teaching information corresponding to the detection result acquired at Step S41 from the user (Step S42), and stores a teaching result thereof in the data storage unit 104 (Step S43).

Next, the information input unit 105 determines whether to end reception of the teaching information (Step S44). In a case of not ending reception of the teaching information (No at Step S44), the process returns to Step S41. In a case of ending reception of the teaching information (Yes at Step S44), the process ends. For example, in a case of receiving an instruction to end input of the teaching information from the user, the information input unit 105 ends reception of the teaching information.

The main procedure of anomaly detection in FIG. 5 and a procedure performed by an information input unit 207 in FIG. 7 are independent of each other. For example, pieces of the teaching information can be collectively input at a timing when the user desires to perform teaching while anomaly detection is performed.

As described above, in the anomaly detection device 100-1 according to the first embodiment, the parameter set storage unit 102 stores the parameter sets used for detecting an anomaly in at least one piece of the target data. The detection unit 103 detects an anomaly in at least one piece of the target data, and acquires at least one detection result by using at least one parameter set selected from the parameter sets. The information input unit 105 receives an input of the teaching information corresponding to the at least one detection result. The processing unit 106 performs at least one of update, addition, and deletion of the parameter set based on the teaching information.

With the above features, according to the anomaly detection device 100-1 of the first embodiment, a larger number of anomalies can be detected with higher detection accuracy. For example, in a case in which the user teaches correct information for the detection result, the score described above is calculated, and the detection accuracy can be improved by repeatedly updating the parameter set. Additionally, in a case in which the detection accuracy is not improved only by updating the existing parameter set, a larger number of anomalies can be detected with high detection accuracy when a new parameter set is added and the parameter sets including the new parameter set are updated. By efficiently causing important data to be the teaching target in accordance with the teaching priority instead of causing all pieces of the target data to be teaching targets, time and effort of the user for teaching can be reduced and the detection accuracy can be efficiently improved.

The information input unit 105 and the processing unit 106 may be implemented as an independent processing device. For example, a processing device may be configured to process a parameter set of an anomaly detection device that detects an anomaly in at least one piece of the target data using a plurality of parameter sets, and include the information input unit 105 that receives an input of teaching information corresponding to the detection result of the target data from the user, and the processing unit 106 that performs at least one of update processing and addition processing of the parameter set based on the input teaching information.

### Second Embodiment

Next, the following describes a second embodiment. In the description about the second embodiment, the same description as that of the first embodiment will not be repeated, and differences from the first embodiment will be described. In anomaly detection according to the second embodiment, used are a plurality of parameter sets from the parameter set storage unit 102 and a tree structure model that is constructed based on a relation among the parameter sets.

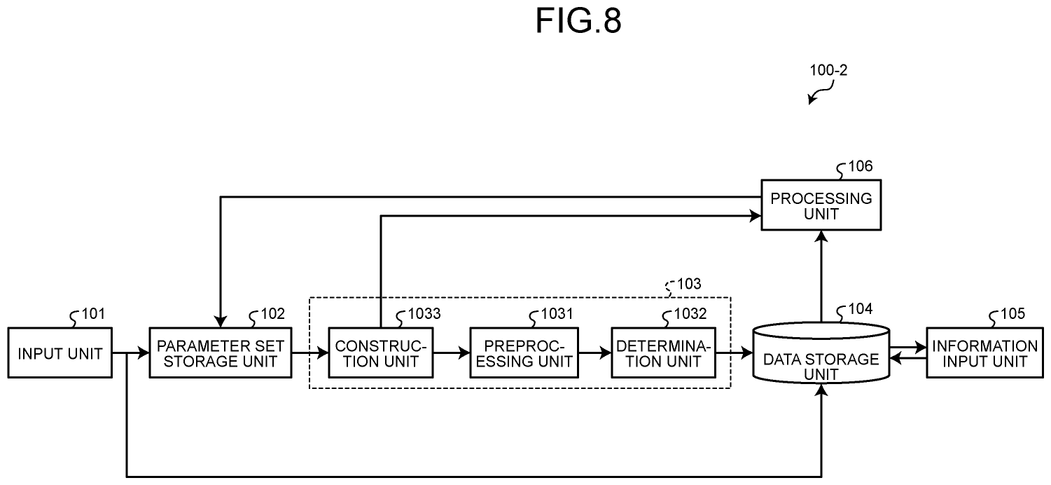

FIG. 8 is a block diagram illustrating an example of a configuration of an anomaly detection device 100-2 according to the second embodiment. The anomaly detection device 100-2 according to the second embodiment includes the input unit 101, the parameter set storage unit 102, the detection unit 103, the data storage unit 104, the information input unit 105, and the processing unit 106. As illustrated in FIG. 8, a construction unit 1033 is added to the detection unit 103 according to the second embodiment in addition to the preprocessing unit 1031 and the determination unit 1032.

The construction unit 1033 is not essential, and a function of the construction unit 1033 may be implemented as one of functions of the parameter set storage unit 102.

In the second embodiment, the parameter set storage unit 102 stores the parameter sets using the tree structure model indicating the relation among the parameter sets. The detection unit 103 detects an anomaly in at least one piece of the target data using at least one parameter set that is selected based on the tree structure model.

In the second embodiment, the tree structure model constructed by a plurality of the parameter sets is processed, so that the anomaly detection method performed by the preprocessing unit 1031 and the determination unit 1032, the determination method for the teaching priority stored in the data storage unit 104, and the processing of update, addition, and deletion of the parameter set performed by the processing unit 106 are different from those in the first embodiment.

### Example of Anomaly Detection Method Using Tree Structure Model

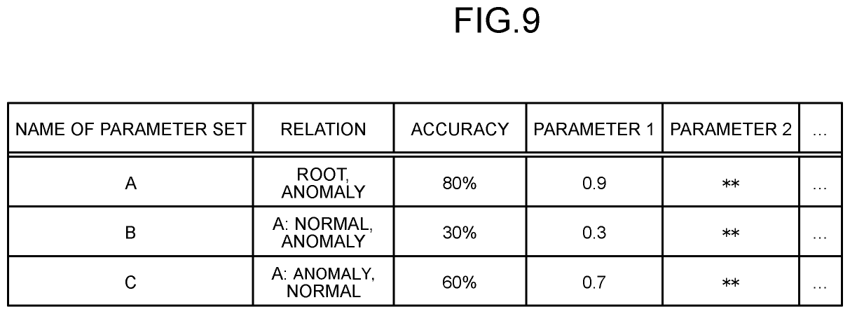

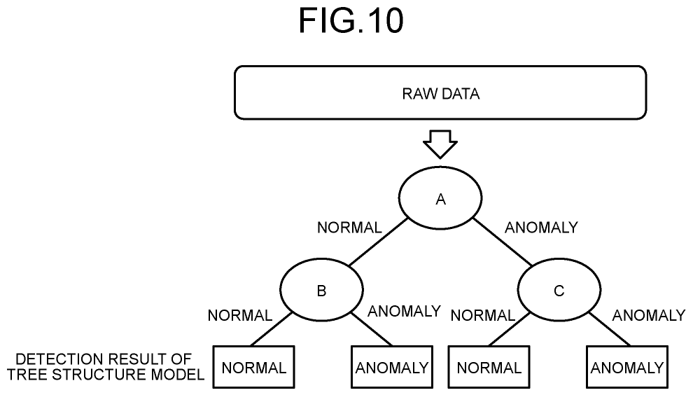

First, the following describes an example of the anomaly detection method using the tree structure model with reference to the examples of FIG. 9 and FIG. 10. FIG. 9 is a diagram illustrating an example of the parameter sets stored in the parameter set storage unit 102 according to the second embodiment. In the example of FIG. 9, the detection accuracy and the relation of the parameter set are stored together with each of the parameter sets. For example, the relation “A: normal, anomaly” of the parameter set B indicates that the parameter is used for suppressing undetection of an anomaly in a case in which normality is determined with the parameter set A.

FIG. 10 is an example of a detection result in the tree structure model according to the second embodiment. The example of FIG. 10 indicates a case in which an anomaly is detected by the tree structure model that is constructed from the parameter set in FIG. 9.

A purpose of the parameter set A is to detect anomalies from all pieces of input data. A purpose of the parameter set B is to suppress undetection of the parameter set A, and causes data determined to be normal with the parameter set A as a detection target. A purpose of the parameter set C is to suppress excessive detection of the parameter set A, and causes data determined to be abnormal with the parameter set A as a detection target.

Due to these facts, in anomaly detection according to the second embodiment, the tree structure model that is constructed as in the example of FIG. 10 is used. In this tree structure model, each node directly receives the raw data, calculates a characteristic space, and determines an anomaly, so that this tree structure model is different from a typical decision tree and the like. In a case in which a plurality of tree structure models are constructed, for example, a final detection result is determined by taking a majority vote from results of the respective tree structure models like a random forest.

### Example of Determination Method for Teaching Priority Using Tree Structure Model

Similarly, with reference to the examples of FIG. 9 and FIG. 10, the following describes an example of a method for determining the teaching priority of the detection result as the teaching target. The tree structure model illustrated in FIG. 10 is used for anomaly detection. The detection unit 103 (determination unit 1032) determines the detection accuracy of the corresponding parameter set based on the detection result of the tree structure model, and determines the teaching priority to be higher as the detection accuracy is lower.

For example, the detection unit 103 determines, to be higher, the teaching priority of the teaching information corresponding to the detection result of the target data that is detected to be normal with a parameter set of a parent node and that is detected to be abnormal with a parameter set of a child node of the parent node in the tree structure model. Additionally, for example, the detection unit 103 determines, to be higher, the teaching priority of the teaching information corresponding to the detection result of the target data that is detected to be abnormal with the parameter set of the parent node and that is detected to be normal with the parameter set of the child node of the parent node in the tree structure model.

In the example of FIG. 10, the parameter set B causes the data determined to be normal with the parameter set A as the detection target. Thus, the data that is detected to be normal with the parameter set A and that is detected to be abnormal with the parameter set B becomes an important detection result of the parameter set B, and the teaching priority of the detection result is determined by using the detection accuracy of B.

The same applies to the parameter set C. The data that is detected to be abnormal with the parameter set A and that is detected to be normal with the parameter set C becomes an important detection result of C, and the teaching priority of the detection result is determined by using the detection accuracy of C.

The detection target of the parameter set A is all pieces of the data, but in a case in which an anomaly is detected with the parameter set A, normality may be detected with the parameter set C in some cases. Thus, only the teaching priority of the data that is detected to be abnormal with the parameter set A and that is detected to be abnormal with the parameter set C is determined by using the detection accuracy of the parameter set A.

The teaching priority of the data other than the data described above, that is, data that is detected to be normal with the parameter set A and that is detected to be normal with the parameter set B, is caused to be 0.

In this way, also in the tree structure model, the teaching priority can be determined for important data with each of the parameter sets. By giving priority to the important data that is detected by using the parameter set the detection accuracy of which is lower, and causing the data to be the teaching target, the detection accuracy can be efficiently improved.

### Example of Update Processing of Parameter Set

Similarly, with reference to the examples of FIG. 9 and FIG. 10, the following describes an example of processing performed by the processing unit 106 using the tree structure model. First, update processing of the parameter set is performed in order from a root to leaves of the tree structure. In the example of FIG. 10, the parameter set A is the root. Thus, the processing unit 106 determines whether to update the parameter set from the parameter set A.

First, the processing unit 106 does not update the parameter set A because the parameter set A has child nodes. This is because data detected by a lower node should not be changed. The parameter set A can be updated, but the following describes an example of not updating the parameter set A.

Next, the process proceeds to a node immediately below. The parameter sets B and C are leaf nodes and do not have a child node, so that the parameter sets B and C are updated. The purpose of the parameter set B is to detect, as an anomaly, the data detected to be normal with the parameter set A. As such, the processing unit 106 searches the parameter sets using the data detected to be normal with the parameter set A as a node immediately above, and selects the parameter set the score of which is the highest. The processing unit 106 then updates the parameter set of the parameter set storage unit 102 and the tree structure model by the selected parameter set.

The same applies to the parameter set C. That is, the processing unit 106 searches the parameter sets using the data detected to be abnormal with the parameter set A, selects the parameter set the score of which is the highest, and updates the parameter set of the parameter set storage unit 102 and the tree structure model by the selected parameter set.

### Example of Deletion Processing of Parameter Set

Next, in a case in which a change between the score before updating the leaf node and the score after updating the leaf node is equal to or larger than the certain value, the processing unit 106 proceeds to processing of determining whether to delete the leaf node. In a case in which the score of the leaf node after the update is smaller than the certain value, the processing unit 106 deletes the parameter set from the parameter set storage unit 102 and the tree structure model. This processing is performed to delete the node the detection accuracy of which is low, the detection accuracy incapable of being improved even if the node is updated. Upper nodes can be deleted in the tree structure model, but influence on the child nodes is large, so that the example of deleting only the leaf node is exemplified herein.

### Example of Addition Processing of Parameter Set

Finally, the processing unit 106 determines whether to add a child node to the leaf node. The processing unit 106 adds a child node in a case in which there is no child node when an anomaly is detected. In a case in which an anomaly is detected, the child node is added for the purpose of suppressing excessive detection (erroneously detecting normality as an anomaly) of the parent node. The same applies to the child node in a case in which normality is detected. In a case in which normality is detected, the child node is added for the purpose of suppressing undetection (erroneously detecting an anomaly as normality) of the parent node.

Specifically, in a case in which the score of the leaf node after the update is equal to or larger than the certain value, the processing unit 106 adds a new parameter set to the parameter set storage unit 102 and the tree structure model to suppress undetection. A condition for the parameter set to be added is, for example, whether the certain number or more of pieces of data are detected to be abnormal in a case in which the data detected to be normal by the parent node is input.

In a case in which the score of the leaf node after the update is smaller than the certain value, the processing unit 106 adds a new parameter set to the parameter set storage unit 102 and the tree structure model to suppress excessive detection. A condition for the parameter set to be added is, for example, whether the certain number or more of pieces of data are detected to be normal in a case in which the data detected to be abnormal by the parent node is input.

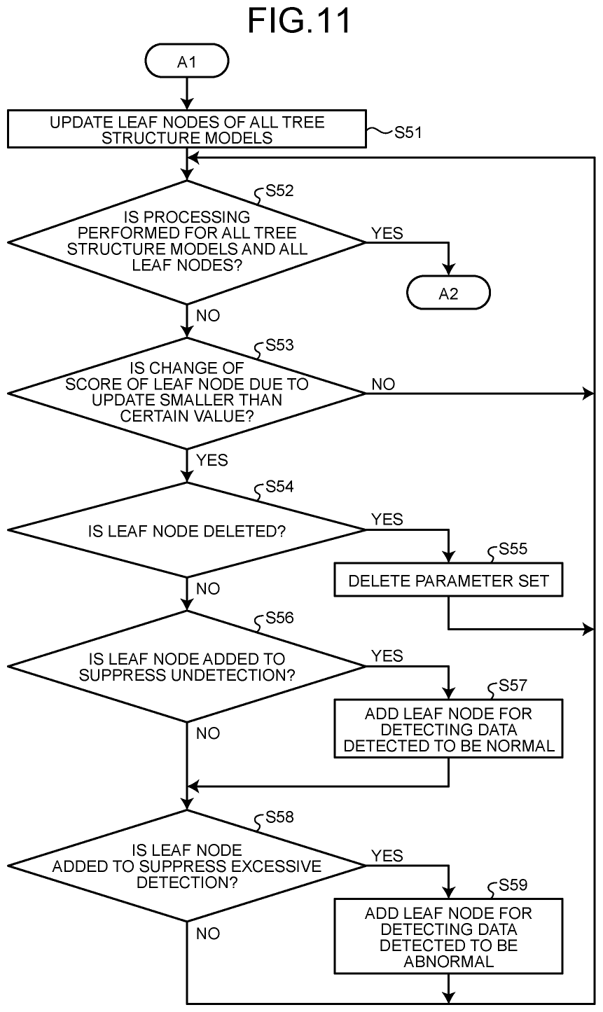

With reference to FIG. 5 and FIG. 11, the following describes an example of the anomaly detection method performed by the anomaly detection device 100-2 according to the second embodiment. In the main procedure of anomaly detection according to the second embodiment, a step of constructing the tree structure model is added after Step S3 in FIG. 5 as the main procedure according to the first embodiment. The processing of performing anomaly detection with each parameter set at Step S4 in FIG. 5 is changed to processing of performing anomaly detection with each tree structure model.

### Operation Example of Processing Unit 106

FIG. 11 is a flowchart illustrating an operation example of the processing unit according to the second embodiment. The following describes a processing procedure performed by the processing unit 106 from A1 in FIG. 11. First, the processing unit 106 performs the update processing (update of the leaf node) described above for all of the tree structure models (Step S51). Next, the processing unit 106 repeatedly performs Step S53 and the following processing for all of the tree structure models and all of the leaf nodes.

If Step S53 and the following processing are not performed for all of the tree structure models and all of the leaf nodes (No at Step S52), the processing unit 106 determines whether a difference (change) between the scores before the update and after the update of the leaf node is smaller than the certain value (first threshold) for unprocessed tree structure models and leaf nodes (Step S53).

If the difference between the scores before the update and after the update of the leaf node is not smaller than the certain value (No at Step S53), the process returns to Step S52.

If the difference between the scores is smaller than the certain value (Yes at Step S53), the processing unit 106 determines whether to delete the leaf node (Step S54). In a case of deleting the leaf node (Yes at Step S54), the processing unit 106 deletes the parameter set corresponding to the leaf node (Step S55), and the process returns to Step S52.

In a case of not deleting the leaf node (No at Step S54), the processing unit 106 determines whether to add a leaf node (new parameter set) for suppressing undetection (Step S56). In a case of adding the new parameter set (Yes at Step S56), the processing unit 106 adds a leaf node for detecting data (that has been) detected to be normal by the parent node as the new parameter set for suppressing undetection (Step S57), and the process returns to Step S52.

In a case of not adding the new parameter set for suppressing undetection (No at Step S56), the processing unit 106 determines whether to add a leaf node (new parameter set) for suppressing excessive detection (Step S58). In a case of adding the new parameter set (Yes at Step S58), the processing unit 106 adds a leaf node for detecting data (that has been) detected to be abnormal by the parent node as the new parameter set for suppressing excessive detection (Step S59), and the process returns to Step S52.

If Step S53 and the following processing are performed for all of the tree structure models and all of the leaf nodes (Yes at Step S52), the process proceeds to A2 in FIG. 5 described above, and the processing ends.

As described above, in the second embodiment, undetection and excessive detection by the parent node can be suppressed when the tree structure model is constructed. A node can be added to each node of the tree structure model constructed from a plurality of the parameter sets for the purpose of suppressing excessive detection and suppressing undetection. The leaf node performs detection only in a case in which normality or an anomaly is determined by the parent node, so that it is sufficient that the leaf node performs learning on corresponding data in a case in which normality or an anomaly is determined by the parent node. Thus, the determination unit 1032 can efficiently improve the detection accuracy by determining the teaching priority of the detection result as the teaching target and causing the teaching priority of the important data to be higher as described above. With these features, time and effort of the user can be reduced.

### Third Embodiment

Next, the following describes a third embodiment. In the description about the third embodiment, the same description as that of the first embodiment will not be repeated, and differences from the first embodiment will be described. In the third embodiment, at the time when the parameter set is updated, added, and deleted, a result thereof is displayed to enable the user to check the result and select whether to perform processing.

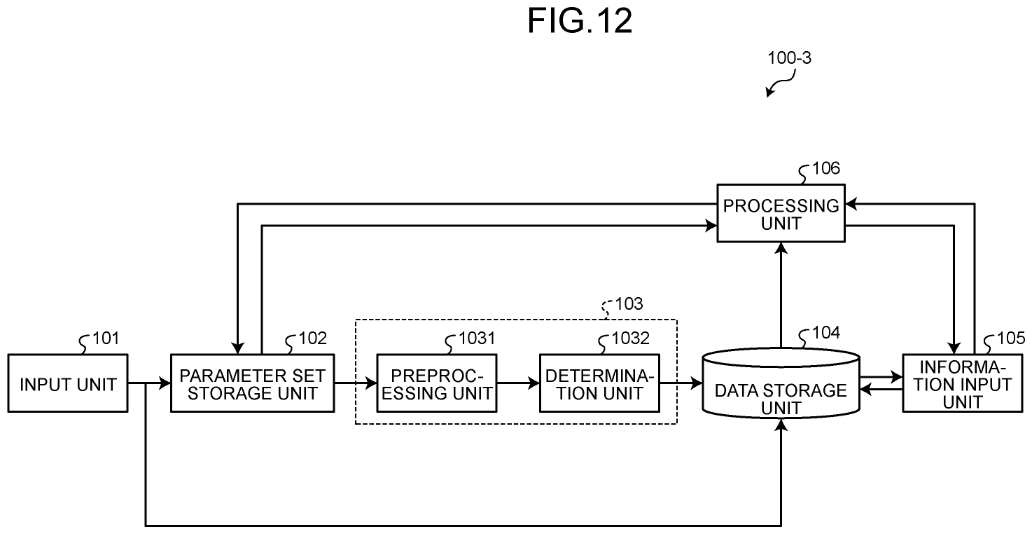

FIG. 12 is a block diagram illustrating an example of a configuration of an anomaly detection device 100-3 according to the third embodiment. The anomaly detection device 100-3 according to the third embodiment includes the input unit 101, the parameter set storage unit 102, the detection unit 103 (the preprocessing unit 1031 and the determination unit 1032), the data storage unit 104, the information input unit 105, and the processing unit 106.

As illustrated in FIG. 12, a path from the processing unit 106 to the information input unit 105 (input interface) and a path from the information input unit 105 to the processing unit 106 are added to the detection unit 103 according to the third embodiment. This configuration can also be applied to the second embodiment illustrated in FIG. 8 described above, and these paths may be added to the configuration according to the second embodiment.

In the third embodiment, the path from the processing unit 106 to the information input unit 105 is added, so that a result can be displayed to the user to enable the user to check the result at the time when the processing of updating, adding, and deleting the parameter set is performed. The path from the information input unit 105 to the processing unit 106 is also added thereto, so that the user is enabled to select whether to perform the processing after checking the displayed result. Furthermore, when an instruction of the user is transmitted from the information input unit 105 to the processing unit 106, the processing unit 106 can be caused to operate at an optional timing.

At the time of updating the parameter set, the processing unit 106 according to the third embodiment inputs a detection result before the update and a detection result after the update to the information input unit 105. This enables the user to check the detection result before the update and the detection result after the update; and therefore, the parameter set can be prevented from being updated in a user-unintended direction.

### Example of Update Check Information Input

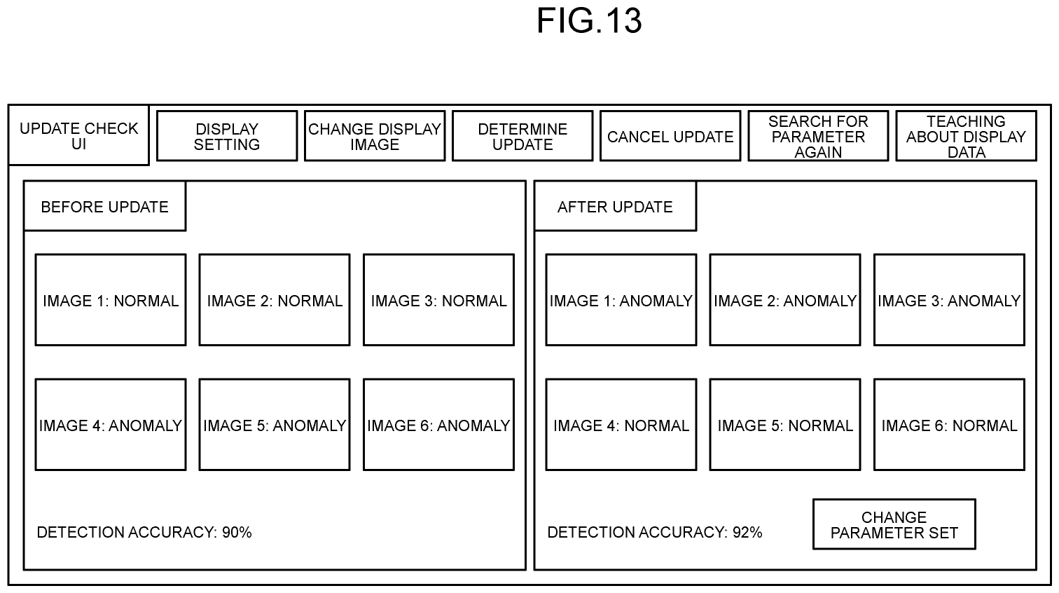

FIG. 13 is a diagram illustrating an example of display information according to the third embodiment (in a case of update check). With reference to the example of FIG. 13, the following describes an example of information input performed by displaying the detection result before the update and the detection result after the update and receiving selection from the user. FIG. 13 illustrates an example in which the detection results are different regarding the same data before the update and after the update of the parameter set. The detection accuracy at the time when anomaly detection is performed with each parameter set is also displayed. The detection accuracy is determined based on the teaching information taught by the user, so that anomaly data (erroneously detected data) may be included in untaught data and the like. Even if the detection accuracy is higher, an anomaly is not correctly detected in the untaught data and the like in some cases.

In this way, before the parameter set is updated by the processing unit 106, the information input unit 105 according to the third embodiment displays the detection result before the update of the parameter set and the detection result after the update of the parameter set, and receives an input indicating whether to update the parameter set from the user. When the user checks the data in which the detection result is changed due to the update, the parameter set can be prevented from being updated in a user-unintended direction. Additionally, regarding the anomaly data, the detection accuracy can be calculated more accurately by receiving the teaching information from the user. In a case of receiving the teaching information regarding the anomaly data from the user, the processing unit 106 performs the processing again from search for the parameter set that improves the detection accuracy including the anomaly data.

### Example of Deletion Check Information Input

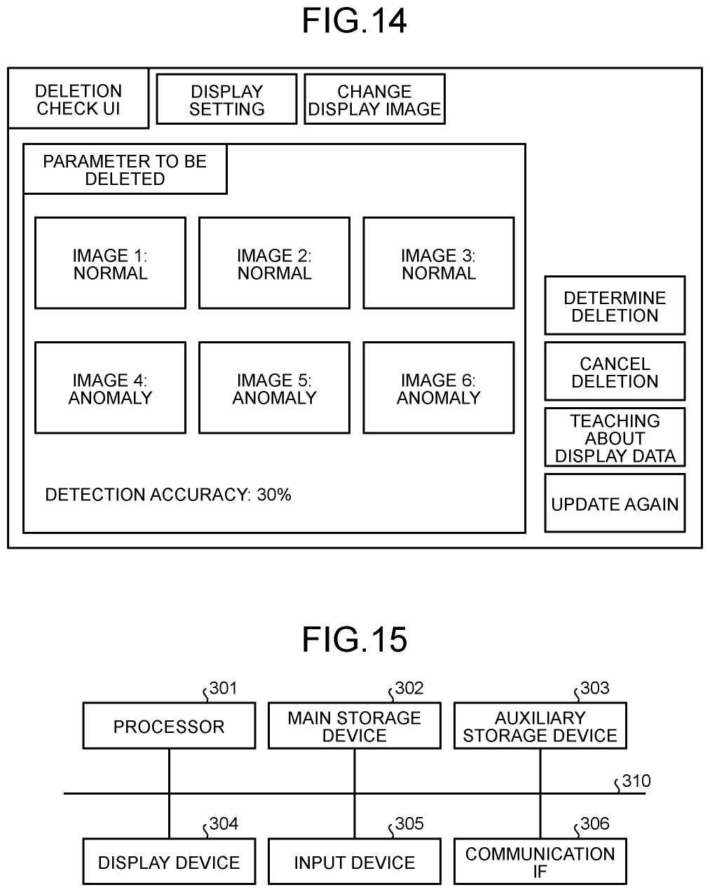

FIG. 14 is a diagram illustrating an example of display information according to the third embodiment (in a case of deletion check). At the time when deletion of the parameter set is determined, the information input unit 105 displays the detection result with the parameter set. FIG. 14 illustrates an example of the display information in which the detection result of the parameter set to be deleted is displayed, the display information for receiving an input for selecting whether to perform deletion from the user. By providing the information input as illustrated in FIG. 14, the parameter set required by the user can be prevented from being deleted.

### Example of Addition Check Information Input

At the time of adding a new parameter set, by displaying a result of the parameter set to enable the user to check the result, the parameter set not intended by the user can be prevented from being added. By using an addition check information input similar to FIG. 14, the user is enabled to select whether to add a new parameter set.

As described above, in the third embodiment, the path from the processing unit 106 to the information input unit 105 and the path from the information input unit 105 to the processing unit 106 are added, so that the user can check the result and select whether to perform update processing, deletion processing, or addition processing by the processing unit 106. When the detection accuracy is calculated based on the teaching information taught by the user and the processing is performed, calculation of the detection accuracy may become unstable in a case in which an amount of the teaching information is small or a case in which inaccurate teaching information is mixed in. Thus, in the third embodiment, by the user's checking of the result, proceeding of update processing, deletion processing, or addition processing performed by the processing unit 106 in a user-unintended direction is preventable.

Finally, the following describes an example of a hardware configuration of the anomaly detection device 100 (100-1 to 100-3) according to the first to the third embodiments.

### Example of Hardware Configuration

FIG. 15 is a diagram illustrating an example of the hardware configuration of the anomaly detection device 100 (100-1 to 100-3) according to the first to the third embodiments. The anomaly detection device 100 includes a processor 301, a main storage device 302, an auxiliary storage device 303, a display device 304, an input device 305, and a communication IF 306. The processor 301, the main storage device 302, the auxiliary storage device 303, the display device 304, the input device 305, and the communication IF 306 are connected via a bus 310.

The processor 301 executes a computer program that is read out from the auxiliary storage device 303 to the main storage device 302. The main storage device 302 is a memory such as a read only memory (ROM) and a random access memory (RAM). The auxiliary storage device 303 is a hard disk drive (HDD), a solid state drive (SSD), a memory card, and the like.

The display device 304 displays a state and the like of the anomaly detection device 100. The input device 305 receives an input from the user. The anomaly detection device 100 does not necessarily include the display device 304 and the input device 305.

The communication IF 306 is an interface for communicating with other devices. In a case in which the anomaly detection device 100 does not include the display device 304 and the input device 305, for example, a display function and an input function of an external terminal connected via the communication IF 306 may be used.

The computer program executed by the anomaly detection device 100 is stored in a computer-readable storage medium such as a CD-ROM, a memory card, a CD-R, and a digital versatile disc (DVD), as an installable or executable file, and provided as a computer program product.

The computer program executed by the anomaly detection device 100 may be stored in a computer connected to a network such as the Internet and provided by being downloaded via the network.

The computer program executed by the anomaly detection device 100 may be provided via a network such as the Internet without being downloaded.

The computer program executed by the anomaly detection device 100 may be embedded and provided in a ROM, for example.

The computer program executed by the anomaly detection device 100 has a module configuration including functions that can be implemented by the computer program in a functional configuration of the anomaly detection device 100 described above. The function implemented by the computer program is loaded into the main storage device 302 when the processor 301 reads out, from the storage medium such as the auxiliary storage device 303, and executes the computer program. That is, the function implemented by the computer program is generated on the main storage device 302.

Part or all of the functions of the anomaly detection device 100 may be implemented by hardware such as an integrated circuit (IC). The IC is, for example, a processor that performs dedicated processing.

In a case of implementing the respective functions using a plurality of processors, each of the processors may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anomaly detection device comprising:
a parameter set storage device configured to store therein a plurality of parameter sets used for detecting an anomaly in at least one piece of target data; and
one or more hardware processors communicably coupled to the parameter set storage device and configured to function as:
a detection unit configured to detect an anomaly in the at least one piece of target data using at least one parameter set selected from the parameter sets, and acquire at least one detection result;
an information input unit configured to receive an input of teaching information corresponding to the at least one detection result; and
a processing unit configured to perform at least one of update, addition, and deletion of the parameter set based on the teaching information.

2. The anomaly detection device according to claim 1, wherein the processing unit calculates a score of a parameter set based on a predetermined score function in a case in which an update condition is satisfied, and deletes the parameter set in a case in which a change of the score between before update of the parameter set and after update of the parameter set is smaller than a first threshold and the score after the update of the parameter set is smaller than a second threshold.

3. The anomaly detection device according to claim 2, further comprising:
a data storage device configured to store therein the teaching information, wherein
the update condition is that a number of pieces of the teaching information stored in the data storage device is increased by a certain number or more.

4. The anomaly detection device according to claim 2, wherein, in a case in which an addition condition is satisfied, the processing unit adds a new parameter set for re-detecting target data detected to be normal to suppress undetection of the anomaly.

5. The anomaly detection device according to claim 2, wherein, in a case in which an addition condition is satisfied, the processing unit adds a new parameter set for re-detecting target data determined to be abnormal to suppress excessive detection of the anomaly.

6. The anomaly detection device according to claim 4, wherein the addition condition is that, between before the update of the parameter set and after the update of the parameter set, the change of the score is smaller than the first threshold and the score after the update of the parameter set is equal to or larger than the second threshold.

7. The anomaly detection device according to claim 1, wherein
the parameter set storage device stores therein the parameter sets by a tree structure model indicating a relation among the parameter sets, and
the detection unit detects an anomaly in the at least one piece of target data using at least one parameter set that is selected based on the tree structure model.

8. The anomaly detection device according to claim 7, wherein the detection unit determines, to be higher, a teaching priority of teaching information corresponding to a detection result of target data that is detected to be normal with a parameter set of a parent node and that is detected to be abnormal with a parameter set of a child node of the parent node in the tree structure model.

9. The anomaly detection device according to claim 7, wherein the detection unit determines, to be higher, a teaching priority of teaching information corresponding to a detection result of target data that is detected to be abnormal with a parameter set of a parent node and that is detected to be normal with a parameter set of a child node of the parent node in the tree structure model.

10. The anomaly detection device according to claim 8, wherein the information input unit displays the detection result of the target data in accordance with the teaching priority, and receives an input of teaching information corresponding to the displayed detection result of the target data.

11. The anomaly detection device according to claim 10, wherein the information input unit displays a detection result before update of the parameter set and a detection result after update of the parameter set before the parameter set is updated by the processing unit, and receives an input indicating whether to update the parameter set from a user.

12. A processing device configured to process a plurality of parameter sets of an anomaly detection device that detects an anomaly in at least one piece of target data using the parameter sets, the processing device comprising:
an information input unit configured to receive an input of teaching information corresponding to a detection result of the target data from a user; and
a processing unit configured to perform at least one of update and addition of the parameter set based on the input teaching information.

13. An anomaly detection method implemented by a computer, the method comprising:
storing, by an anomaly detection device, a plurality of parameter sets used for detecting an anomaly in at least one piece of target data;
detecting, by the anomaly detection device, an anomaly in the at least one piece of target data using at least one parameter set selected from the parameter sets, and acquiring at least one detection result;
receiving, by the anomaly detection device, an input of teaching information corresponding to the at least one detection result; and
performing, by the anomaly detection device, at least one of update, addition, and deletion of the parameter set based on the teaching information.

14. A computer program product having a non-transitory computer readable medium including programmed instructions stored thereon, wherein the instructions, when executed by a computer, cause the computer to function as:
a parameter set storage unit configured to store therein a plurality of parameter sets used for detecting an anomaly in at least one piece of target data;
a detection unit configured to detect an anomaly in the at least one piece of target data using at least one parameter set selected from the parameter sets, and acquire at least one detection result;
an input unit configured to receive an input of teaching information corresponding to the at least one detection result; and
a processing unit configured to perform at least one of update, addition, and deletion of the parameter set based on the teaching information.
